(19) United States
(12) Patent Application Publication
(10) Pub. No.: US 2014/0279713 A1
(43) Pub. Date: Sep. 18, 2014

(54) AUTOMATED PAYMENT FOR A RENTAL PERIOD BASED ON DETERMINING THE LOCATION OF A RENTER'S MOBILE COMMUNICATION DEVICE

(71) Applicant: BANK OF AMERICA CORPORATION, Charlotte, NC (US)

(72) Inventors: Matthew A. Calman, Charlotte, NC (US); David M. Grigg, Rock Hill, SC (US); Scott Lee Harkey, Concord, NC (US); Laura Corinne Bondesen, Charlotte, NC (US)

(73) Assignee: Bank of America Corporation, Charlotte, NC (US)

(21) Appl. No.: 13/828,155

(22) Filed: Mar. 14, 2013

(51) Int. Cl. G06Q 30/02

(52) U.S. Cl. CPC G06Q 30/0284
USPC 705/418

(57) ABSTRACT

Systems, apparatus, methods and computer programs provide for self-service rental of rental items. The self-service aspect of the invention allows for renters to obtain the rental, leave the rental agency facility, return the rental item and pay for the rental without having to come into contact with anyone at the rental agency. The invention implements a renter's mobile device. In this regard, the mobile device receives information related to the rental item that the renter desires to rent and initiates the self-service process. The rental period is defined by the time at which the mobile device, equipped with location-determining mechanisms, departs a designated rental area and the time at which the mobile device returns to the same or another designated rental area. Once the rental period is known, the rental period payment amount can be determined based on a predetermined rental rate and payment provided.

### FIELD OF THE INVENTION

In general, embodiments herein disclosed relate to commerce and, more specifically providing automated payment amount determination for a rental period based on determining the location of a renter's mobile communication device.

### BACKGROUND

Both rental providers and those who rent items, such as vehicles, equipment or the like desire efficient and accurate means for paying for the rental. For example, car rental agencies and the like typically require customers to wait in line at the agency counter in order to secure a vehicle, provide identification, payment means and the like. This can be a time-consuming endeavor. While preferred programs have allowed renters to bypass the agency and proceed directly to the rental vehicle, the renter typically has to show identification to a kiosk attendant or the like prior to departing the rental facility. From the vehicle return perspective, while inroads have been made to eliminate the need for most renters to check-in their returned vehicle at an agency counter, the renter still needs to engage a check-in attendant who performs the function of verifying mileage/vehicle condition and finalizes the rental transaction (i.e., charges the renter's account and provides a receipt).

For other rental items, such as equipment rentals and the like the process is typically much more laborious and inefficient. This is due at least in part to the fact that frequent rentals of such equipment by individuals are rare and therefore, unlike the car rental example, frequent rental programs are not prevalent. The renter is typically burdened with waiting in line to rent the equipment and waiting in line upon returning the equipment.

In both the vehicle rental and equipment rental examples employees are needed to process both the vehicle/equipment check-out and vehicle/equipment check-in. The need for such manpower to process the rental invariably increases the overall cost of the rental. Such costs are either passed along to the renter or absorbed by the rental agency/entity.

Therefore, a need exists to create new ways for rental providers to allow renters to pay for a rental. The desired systems and methodologies should allow for automated payment that circumvents the need for the renter to wait in line to check-out, check-in and/or make payment. In addition, the desired systems and methodologies should provide precise and accurate measurement of the rental period such that the renter is charged for the period of time that the rental occurred.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

Methods, apparatus systems and computer program products are described herein that provide for self-service rental of rental items, such as vehicles, equipment and the like. The self-service aspect of the invention allows for renters to obtain the rental, leave the rental agency facility, return the rental item and pay for the rental without having to come into contact with anyone at the rental agency. The invention implements a renter's mobile communication device, e.g., smart telephone or the like. In this regard, the mobile communication device receives information related to the rental item that the renter desires to rent. The information may be manually entered by the renter or received through more automated means, such as capture of computer-readable indicia, barcode or the like, or through short-range wireless transmission, e.g., Near Field Communication (NFC), 2400-2483.5 MHz band communication or the like. The receipt of such information by the mobile communication indicates the renter's desire to rent the item and initiates the self-serve process. In specific embodiments, receipt of the rental item information will prompt the mobile communication device to communicate renter authentication credentials (e.g., driver's license data. Payment account information or the like, to the rental agency to verify the entity of the individual renting the item. The rental period is defined by the time at which the mobile device, equipped with location-determining mechanisms and in possession of the renter, departs a designated geo-fenced rental area and the time at which the mobile device, equipped with location-determining mechanisms returns to the designated geo-fenced rental area (or arrives at another designated geo-fenced area, e.g., a different designated rental agency or the like). Once the rental period is known, the rental period payment amount can be determined based on a predetermined rental rate. In specific embodiments of the invention determination of the rental period payment amount prompts automated communication of a payment identifier, such as payment account information, to the rental agency/entity for remitting payment of the payment amount.

As such the present invention, eliminates the need for a renter to wait in line or otherwise encounter rental agency representatives during the rental and rental return process, thereby making the rental process more efficient to the renter. Additionally, by eliminating the need for the renter to encounter rental agency representatives, the rental agency benefits by minimizing the overhead costs associated with employing rental agency representatives.

An apparatus for automated determination of a rental period payment amount defines first embodiment of the invention. The apparatus includes a mobile communication device including a computing platform having a processor, a memory in communication with the processor and a location-determining device in communication with the processor. The apparatus further includes a rental application stored in the memory of the mobile communication device and executable by the processor. The rental application is configured to receive rental item information that indicates the renter's desire to rent an identified rental item and enables automated self-service rental and payment processing. In response to receiving the rental item information, the application is further configured to implement the location-determining device to determine and record a first time at which the mobile communication device departs a first designated rental area, such as a geo-fenced region surrounding the perimeter of the rental agency or the like. Further, the application is configured to implement the location-determining device to determine and record a second time at which the mobile communication enters a second designated rental area (i.e., the same designated rental area as from where the renter departed or, in the event that the renter returns the item to a different rental agency, a different designated rental area). In addition, the rental application is configured to determine a rental period payment amount for the rental period based on the first time, the second time and a predetermined time-based payment rate.

In additional specific embodiments of the apparatus, the rental application is further configured to, in automatic response to determining the payment amount, communicate, to a rental entity providing the rental item, a payment identifier associated with a payment account, such that the payment identifier provides for payment of the rental period payment amount. In such embodiments of the apparatus, the rental application is further configured to, in response to communicating the payment identifier, receive a payment receipt that indicates the payment amount for renting the rental item for the payment period.

In other specific embodiments of the apparatus, the rental application is further configured to, in response to receiving the rental item information, communicate authentication credentials to a rental entity renting the rental item, such that receipt of the authentication credentials by the rental entity provides for authenticating the renter.

In further specific embodiments of the apparatus, the mobile communication device further includes an image-capturing device and the rental application is further configured to receive the rental item information by implementing the image-capturing device to capture computer-readable indicia associated with a rental item, such that the computer-readable indicia, when read by the mobile communication device, includes the rental item information.

In other specific embodiments of the apparatus, the rental application is further configured to receive return location information, such that the return location information identifies a location within the second designated rental area where the renter has returned the rental item. In such embodiments of the apparatus, the mobile communication device may further include an image-capturing device and the rental application is further configured to receive the location identifier by implementing the image-capturing device to capture computer-readable indicia associated with the location, such that the computer-readable indicia, when read by the mobile communication device, identifies the location.

A method for automated payment of a rental period defines second embodiments of the invention. The method includes receiving, by a mobile communication device, rental item information, such that the rental item information identifies a rental item and enables automated rental and in response to receiving the rental item information, determining, by location determining mechanisms within the mobile communication device, a first time at which a renter, in possession of the mobile communication device and the rental item, departs a first designated rental area. The method further includes determining, by the location determining mechanisms within the mobile communication device, a second time at which the renter, in possession of the mobile communication device and the rental item, enters a second designated rental area and determining, by a computing device, a payment amount for the rental period based on the first time, the second time and a predetermined time-based payment rate.

In specific embodiments the method further includes, in automatic response to determining the payment amount, communicating a payment identifier associated with a payment account, such that the payment identifier provides for payment of the payment amount. In such embodiments the method may further include, in response to communicating the payment identifier, receiving, by the mobile communication, a payment receipt that indicates the payment amount for renting the rental item for the payment period.

In other specific embodiments the method includes, in response to receiving the rental item information, communicating authentication credentials to a rental entity renting the rental item, such that receipt of the authentication credentials by the rental entity provides for authenticating the renter.

In further embodiments of the method receiving the rental item information further includes capturing, by an image capture device within the mobile communication device, first computer-readable indicia associated with a rental item, such that the computer-readable indicia, when read by the mobile communication device, includes the rental item information.

In still further specific embodiments the method includes receiving, by the mobile communication device, return location information, such that the return location information identifies a location within the second designated rental receiving the location identifier further comprises capturing, by an image-capturing device within the mobile communication device, second computer-readable indicia associated with the location, such that the computer-readable indicia, when read by the mobile communication device, identifies the location.

A computer program product including a non-transitory computer-readable medium defines third embodiments of the invention. The medium includes computer-executable instructions to cause a computer to implement steps. The steps include (1) receiving rental item information, such that the rental item information identifies a rental item and enables automated rental and, (2) in response to receiving the rental item information, determining, by location determining mechanisms within a mobile communication device, a first time at which a renter, in possession of the mobile communication device and the rental item, departs a first designated rental area. The steps further include (3) determining, by the location determining mechanisms within the mobile communication device, a second time at which the renter, in possession of the mobile communication device and the rental item, enters a second designated rental area and (4) determining a payment amount for the rental period based on the first time, the second time and a predetermined time-based payment rate.

Thus, systems, apparatus, methods and computer products are described in more detail below that provide for self-service rental of rental items, such as vehicles, equipment and the like. The self-service aspect of the invention allows for renters to obtain the rental, leave the rental agency facility, return the rental item and pay for the rental without having to come into contact with anyone at the rental agency. As such, the present invention eliminates the need for a renter to wait in line or otherwise encounter rental agency representatives during the rental and rental return process, thereby making the rental process more efficient to the renter. Additionally, by eliminating the need for the renter to encounter rental agency representatives, the rental agency benefits by minimizing the overhead costs associated with employing rental agency representatives.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 is a block diagram illustrating a mobile communication device configured for providing automated payment amount determination for a rental period based on determining the location of the mobile communication device, in accordance with an embodiment of the invention;

FIG. 2 is a more detailed block diagram of a mobile communication device configured for providing automated payment amount determination for a rental period based on determining the location of the mobile communication device, in accordance with an embodiment of the invention;

FIG. 3 is a block diagram illustrating a system for providing automated payment amount determination for a rental period based on determining the location of a renter's mobile communication device, in accordance with an embodiment of the invention; and

FIG. 4 is a flow diagram illustrating a method for providing automated payment amount determination for a rental period based on determining the location of a renter's mobile communication device, in accordance with an embodiment of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. In the following description, for purposes of explanation, numerous specific details are set forth in order to provide a thorough understanding of one or more embodiments. It may be evident; however, that such embodiment(s) may be practiced without these specific details. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The steps and/or actions of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some embodiments, the processor and the storage medium may reside in an Application Specific Integrated Circuit (ASIC). In the alternative, the processor and the storage medium may reside as discrete components in a computing device. Additionally, in some embodiments, the events and/or actions of a method or algorithm may reside as one or any combination or set of codes and/or instructions on a machine-readable medium and/or computer-readable medium, which may be incorporated into a computer program product.

In one or more embodiments, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures, and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. “Disk” and “disc”, as used herein, include compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

Methods, apparatus systems and computer program products are described in detail herein that provide for self-service rental of rental items, such as vehicles, equipment and the like. The self-service aspect of the invention allows for renters to obtain the rental, leave the rental agency facility, return the rental item and pay for the rental without having to come into contact with anyone at the rental agency. The invention implements a renter's mobile communication device, e.g., smart telephone or the like. In this regard, the mobile communication device receives information related to the rental item that the renter desires to rent. The information may be manually entered by the renter or received through more automated means, such as capture of computer-readable indicia, barcode or the like, or through short-range wireless transmission, e.g., Near Field Communication (NFC), 2400-2483.5 MHz band communication or the like. The receipt of such information by the mobile communication indicates the renter's desire to rent the item and initiates the self-serve process. In specific embodiments, receipt of the rental item information will prompt the mobile communication device to communicate renter authentication credentials (e.g., driver's license data. Payment account information or the like, to the rental agency to verify the entity of the individual renting the item. The rental period is defined by the time at which the mobile device, equipped with location-determining mechanisms and in possession of the renter, departs a designated geo-fenced rental area and the time at which the mobile device, equipped with location-determining mechanisms returns to the designated geo-fenced rental area (or arrives at another designated geo-fenced area, e.g., a different designated rental agency or the like). Once the rental period is known, the rental period payment amount can be determined based on a predetermined rental rate. In specific embodiments of the invention determination of the rental period payment amount prompts automated communication of a payment identifier, such as payment account information, to the rental agency/entity for remitting payment of the payment amount.

As such the present invention, eliminates the need for a renter to wait in line or otherwise encounter rental agency representatives during the rental and rental return process, thereby making the rental process more efficient to the renter. Additionally, by eliminating the need for the renter to encounter rental agency representatives, the rental agency benefits by minimizing the overhead costs associated with employing rental agency representatives.

FIG. 1 illustrates a block diagram of a mobile communication device 100 for providing automated payment amount determination for a rental period based on determining the location of the mobile communication device, in accordance with specific embodiments of the present invention. The mobile communication device 100 which is in the possession of an individual (referred to herein as “a renter”) desiring to rent an item, such as a vehicle, equipment or the like. The mobile communication device 100 will typically be a smart cellular telephone, however, in other embodiments the mobile communication device may be a personal digital assistant (PDA), a mobile Internet accessing device, a laptop/portable computer, or other mobile communication device capable of executing applications and communicating via a wireless network, which may be a cellular network, and/or a data network, such as the Internet or the like.

The mobile communication device 100 includes a computing platform 102 having a memory 104 and at least one processor 106 in communication with the memory 104. The memory 104 stores rental application 108 that is configured to allow the individual/renter to rent items in a self-service manner without requiring intervention/contact with rental agency representatives during the entire rental process. The rental application 108 may be specific to one rental agency or a chain of rental agencies (e.g., Brand X vehicle rental agency, Brand Y home improvement center, or the like). In such instances the renter may be in trusted relationship with the rental agency, such that the renter is authorized to use the application (i.e., self-service rental) based on the relationship, which may include previously having provided authentication credentials and authorization to charge a designated renter's account in the event of unauthorized actions on behalf of the renter.

The application 108 is configured to receive rental item information 112 that identifies the rental item 114 and tie the rental item 114 to the renter and the mobile communication device 100. Thus, receipt of the rental item 112 information 112 by the mobile communication 100 serves to trigger 116 the automated self-service rental process 116 (i.e., tracking of the rental item location in relation to geo-fenced rental agency areas based on the determined location-determining mechanisms within the mobile communication device). The rental information may be received from the rental agency based on a rental reservation or the application itself may be configured to provide for reservation capabilities. In other embodiments of the invention, in which the renter does not have a reservation or in which the renter, rental item and mobile communication device are required to concurrently present at the rental agency, the renter may manually input the requisite rental item information 112 into the application 108 or the mobile communication may automatically receive the rental item information 112 absent renter input. Such automated means may include implementing an image-capturing device within the mobile communication device to capture computer-readable indicia (e.g., barcode, Quick Response (QR) code) located on or associated with the rental item or receiving the rental item information 112 by implementing short range wireless communication, such as near field communication, 2400-2483.5 MHz band communication to communicate the rental information 112 to the mobile communication device 100.

Thus, in response to receiving the rental item information 112, the application is further configured to implement a timing device, such as clock 111 and location-determining mechanisms 110, such as Global Positioning System devices, cellular network mechanisms or the like, disposed within the mobile communication device 100 to determine, and record in mobile communication device memory, a first time 118 at which the renter, in possession of the rental item 114 and the mobile communication device 100, departs a first designated rental area 120. The first designated rental area 120 is a geo-fenced area defined by the rental agency and includes the area in which the items to be rented, vehicles, equipment or the like, are located prior to being rented. The first designated rental area 120 may surround the perimeter of a rental agency facility or the grounds of a rental facility or may surround an area extended out from the perimeter of the facility/grounds by a certain predetermined distance (in order to insure that the renter has, in fact, left the premise with the rental item 114). The first time 118 indicates the start of the rental period for the rental item.

The application 108 is further configured to implement the timing device such as clock 111 and location-determining mechanisms 110, such as Global Positioning System devices, cellular network mechanisms or the like, disposed within the mobile communication device 100 to determine, and record in mobile communication device memory, a second time 122 at which the renter, in possession of the rental item 114 and the mobile communication device 100, arrives at a second designated rental area 124. The second designated rental area 124 is a geo-fenced area defined by the rental agency and includes the area in which the items to be rented, vehicles, equipment or the like, are to be returned. Thus, the second designated rental area 124 may be the same or similar to the first designated rental area 118 in the event the renter returns the rental item 114 to the same physical location/facility as from where he/she rented the rental item 114. In other embodiments, the second designated rental area 124 may be associated with a different physical location, such as a different rental agency, in the event the rental entity/company allows rental from one rental agency/facility and return to another different agency/facility (e.g., a one-way rental). The second designated rental area 120 may surround the perimeter of a rental agency facility or the grounds of a rental facility or may surround an area internal to the facility/grounds by a certain predetermined distance (in order to insure that the renter is, in fact, returning the rental item 114). Thus, it should be noted that in the instance in which the first and second designated rental areas 120 and 124 are associated with the same rental agency (i.e., same physical location), the first and second designated rental areas 120 and 124 may define different areas to insure that the renter has left the agency with the rental item 114 and insure that the renter has returned with to the rental agency with the rental item 114.

The second time 122 indicates the end of the rental period for the rental item. It should be noted that in the event a second time 122 is proximate in time to the first time 114 such that it does not likely reflect the end time of the rental period it may be disregard for purposes of subsequently determining the rental payment amount (e.g., the renter returns to the rental agency shortly after renting the rental item for various different reasons).

The rental application is further configured to, in response to determining the second time 122 or confirming that the second time 122 is indicative of the time at which the rental item 114 is returned, to determine a rental period payment amount 126. The rental period payment amount 126 is determined based on the first time 118 and the second time 122 defining the rental period and a predetermined time-based payment rate 128, such as specified amount per day, specified amount per hour, specified amount per minute or the like. As noted, in specific embodiments a confirming event/action may be required to insure that the second time 122 is in fact associated with the return of the rental item 114 to the rental agency and not just an arrival at the second designated rental area 124 without having an intention to return the rental item 114.

Referring to FIG. 2, shown is a more detailed block diagram of the mobile communication device 100, according to embodiments of the present invention. The mobile communication device 100 is configured to providing automated payment amount determination and payment for a rental period based on determining the location of the mobile communication device. In addition to providing greater detail, FIG. 2 highlights various alternate embodiments of the invention.

The mobile communication device 100 includes computing platform 102 that can receive and execute algorithms, such as routines, and applications. Computing platform 102 includes memory 104, which may comprise volatile and non-volatile memory, such as read-only and/or random-access memory (RAM and ROM), EPROM, EEPROM, flash cards, or any memory common to computer platforms. Further, memory 104 may include one or more flash memory cells, or may be any secondary or tertiary storage device, such as magnetic media, optical media, tape, or soft or hard disk.

Further, computing platform 102 also includes processor 106, which may be an application-specific integrated circuit (“ASIC”), or other chipset, processor, logic circuit, or other data processing device. Processor 106 or other processor such as ASIC may execute an application programming interface (“API”) (not shown in FIG. 2) that interfaces with any resident programs, such as rental application 108 and algorithms associated therewith or the like stored in the memory 104 of the mobile communication device 100.

Processor 106 includes various processing subsystems embodied in hardware, firmware, software, and combinations thereof, that enable the functionality of mobile communication device 100 and the operability of the apparatus on a network. For example, processing subsystems allow for initiating and maintaining communications and exchanging data with other networked devices. For the disclosed aspects, processing subsystems of processor 104 may include any subsystem used in conjunction with rental application 108 and related algorithms, sub-algorithms, sub-modules thereof.

Computer platform 102 may additionally include communications module (not shown in FIG. 2) embodied in hardware, firmware, software, and combinations thereof, that enables communications among the various components of the mobile communications device 100, as well as between the other networked devices. Thus, the communication module may include the requisite hardware, firmware, software and/or combinations thereof for establishing a network communication connection and communicating information to a computing device, such as a rental agency computing device/server or a financial institution computing device/server for the purpose of paying for the rental.

As previously described in relation to FIG. 1, the memory 104 stores rental application 108 that is configured to allow the individual/renter to rent items in a self-service manner without requiring intervention/contact with rental agency representatives during the entire rental process. The application 108 is configured to receive rental item information 112 that identifies the rental item 114 and tie the rental item 114 to the renter and the mobile communication device 100. Thus, receipt of the rental item 112 information 112 by the mobile communication 100 serves to trigger 116 the automated self-service rental process 116 (i.e., tracking of the rental item location in relation to geo-fenced rental agency areas based on the determined location-determining mechanisms within the mobile communication device). The rental information may be received from the rental agency based on a rental reservation or the application itself may be configured to provide for reservation capabilities. In other embodiments of the invention, in which the renter does not have a reservation or in which the renter, rental item and mobile communication device are required to concurrently present at the rental agency, the renter may manually input the requisite rental item information 112 into the application 108 or the mobile communication may automatically receive the rental item information 112 absent renter input. Such automated means may include implementing an image-capturing device 134 within the mobile communication device to capture computer-readable indicia (e.g., barcode, Quick Response (QR) code) located on or associated with the rental item or receiving the rental item information 112 by implementing short range wireless communication 136, such as near field communication, 2400-2483.5 MHz band communication to communicate the rental information 112 to the mobile communication device 100.

In additional embodiments of the invention, the rental application 100 is further configured to communicate authentication credentials 138 to the rental agency as a prerequisite to renting the rental item 114. The authentication credentials 138, which are stored on the mobile communication device, may include a virtual driver's license, driver's license information or the like, that upon receipt and processing by the rental agency or third party authentication entity serves to verify that the mobile communication device is associated with an individual who is enrolled in the trust-based self-service rental program or is otherwise authorized to participate in the self-service rental program. In addition, the authentication credentials 138 may include a payment account identifier (not shown in FIG. 3). In such instances, the payment account identifier may further serve to authorize the renter based on the payment account being verified as being sufficient to cover the cost of the rental and/or damages/loss of the rental item 114. It should be noted that the authentication credentials 138 may be communicated in automatic response to receiving the rental item information 112, at the bequest of the application/rental agency (e.g., the mobile communication device receives an authentication credential alert or the like). The application 108 may be configured such that only certain rentals require communication of authentication credentials, based on the type of the rental, the length of the rental, the cost of the rental or the like. In those embodiments in which authentication credentials 138 are communicated, the application 108 may receive rental authentication 140 which is configured to allow the renter to rent the rental item 114. The rental authentication 140 which may include computer-readable indicia, such as bar-code or the like, serves to indicate that the renter is in rightful possession of the rental item and is authorized to depart the rental agency with the rental item 114. In the event the renter is stopped by a rental agency representative as they depart the facility, the rental authentication 140 may be shown to the representative (and the computer-readable indicia captured by code-reading device in possession of the representative) to verify that the renter is authorized for the rental and, thus, within right to depart the rental agency with the rental item 114.

Thus, as previously discussed in relation to FIG. 1, in response to receiving the rental item information 112 (and/or receiving rental authorization 140), the application 108 is further configured to implement a timing device, such as clock 111 and location-determining mechanisms 110, such as Global Positioning System devices 130, cellular network mechanisms 132 or the like, disposed within the mobile communication device 100 to determine, and record in mobile communication device memory, a first time 118 at which the renter, in possession of the rental item 114 and the mobile communication device 100, departs a first designated rental area 120. The first designated rental area 120 is a geo-fenced area defined by the rental agency and includes the area in which the items to be rented, vehicles, equipment or the like, are located prior to being rented. The first time 118 indicates the start of the rental period for the rental item 114.

The application 108 is further configured to implement the timing device such as clock 111 and location-determining mechanisms 110, such as Global Positioning System devices 130, cellular network mechanisms 132 or the like, disposed within the mobile communication device 100 to determine, and record in mobile communication device memory, a second time 122 at which the renter, in possession of the rental item 114 and the mobile communication device 100, arrives at a second designated rental area 124. The second designated rental area 124 is a geo-fenced area defined by the rental agency and includes the area in which the items to be rented, vehicles, equipment or the like, are to be returned. The second time 122 indicates the end of the rental period for the rental item.

The application 108 may further be configured to receive, and subsequently communicate to the rental agency, return location information 142 that is configured to provide the rental agency confirmation of the return of the rental item as well the item location 146 within the second designated rental area 124. In specific embodiments, the renter may provide input to the application to identify the item location 146 or the renter may capture, using image capture device 134, computer-readable indicia associated with the item location 146 (e.g., a bar code on a parking space, a shelf location or the like) or tags on the rental item 114 and the item location 146 may provide for short range wireless communication which may be read by an associated short range wireless communication module 136 within the mobile communication device 100. Verification that the rental item 114 is actually located at the item location 146 may be accomplished by capturing an image of the rental item in the item location 146, capturing computer-readable code from the item 114 and the item location 146 within a predetermined period of time and/or short-range wireless communication between tags disposed on the rental item and the item location 146. In such embodiments of the invention in which return location information 142 is required, the return location information 142 may serve as confirmation that the associated second time 122 is, in fact, the time at which the rental item 114 was returned. In other embodiments of the invention, the time at which the return location information 142 is communicated to the rental agency may define the second time 122 obviating the need to determine the second time 122 defined as the time at which the renter, in possession of the rental item 114 and the mobile communication device 100, arrives at the second designated rental area 124.

In optional embodiments of the invention, the rental item 114 may be configured to provide diagnostic information or status information (not shown in FIG. 3) to the application 108 through the mobile communication device 100. Such information may be communicated through short range wireless communication or the like. For example, a vehicle may communicate fuel level, mileage information, performance information or the like. In such embodiments, the application 108 may be configured to communicate the information to the rental agency, either separately or in unison with the return location information 142. In additional embodiments of the invention, the communication that includes the diagnostic/status information and/or the return location information 142 may provide for the renter to input comments or the like, which indicate the performance of the rental item 114 or the need for service of the rental item 114.

The rental application 108 is further configured to, in response to determining the second time 122 and/or confirming that the second time 122 is indicative of the time at which the rental item 114 is returned and/or verifying the item location 146 of the rental item 146, to determine the rental period payment amount 126. The rental period payment amount 126 is determined based on the first time 118 and the second time 122 defining the rental period and a predetermined time-based payment rate 128, such as specified amount per day, specified amount per hour, specified amount per minute or the like. As noted, in specific embodiments a confirming event/action may be required to insure that the second time 122 is in fact associated with the return of the rental item 114 to the rental agency and not just an arrival at the second designated rental area 124 without having an intention to return the rental item 114.

In specific embodiments of the invention, the application 108 is further configured to authorize payment of the determined payment amount 126. The authorization may be for the full amount or a portion of the full amount in the event the renter provided a partial down payment prior to the rental. In the event that the rental has not previously provided the rental agency with payment information or if the renter wishes to override the payment information previously provided (e.g., pay with a different payment account/vehicle than the payment account previously provided at the time of rental or the payment account identified in a renter profile), the application 108, at the bequest of the renter or automatically in response to determining the payment amount, may communicate a payment identifier or authorization for payment 148 to the rental agency. The payment identifier 148 may serve to identify the payment account 150 which the renter desires to be applied for settlement of the rental period payment amount 126 or the outstanding portion of rental period payment amount 126.

In response to the rental agency receiving payment or confirmation that the renter has authorized payment of the payment amount 128, the application 108 is configured to a payment receipt 152 which indicates the payment amount 154. The payment amount 154 may be equivalent to the rental period payment amount 128 or the payment amount 154 may reflect any additional charges (e.g., fuel charges for a vehicle rental) or discounts applicable to the rental or specific to the renter.

Referring to FIG. 3, a system 300 for providing automated payment amount determination and payment for a rental period based on determining the location of the mobile communication device. The system 300 includes a mobile communication device 100 in communication with a computing device 200 via communication network 500, which may be a cellular network or the like. The mobile communication device 100 depicted in the system 300 of FIG. 3 includes elements described in relation to FIGS. 1 and 2 and, as such, for the sake of brevity and eliminating redundancy will not be described in relation to FIG. 3.

The computing device 200 which may be a server residing at the rental agency or physically located outside of the rental agency, includes a computing platform 202 having a memory 204 and a processor 206 in communication with the memory 204. The memory stored rental processing module 208 that is executable by the processor 206 and configured to process rentals and, specifically, self-service rentals accomplished via mobile communication device 100. Thus, rental processing module 208 may be configured to receive the authentication credentials 138 communicated from the wireless communication device 100 and perform the requisite verification of the authentication credentials 138 to insure that the wireless device is associated with a renter who is authorized to participate in the self-service rental program. In this regard, the module 208 may be configured to apply the authentication credentials 138 to a database of registered or authorized self-service rental users to verify that the renter is authorized to rent in this fashion. Once the renter is verified, the rental processing module 208 will communicate rental authorization 140 to the application 108 executing on wireless communication device 100. In addition, as previously noted, the authentication credentials may include payment information necessary to authorize the renter to perform the rental. In such embodiments, the rental processing module 208 may communicate with a financial institution or other entity associated with the renter's payment account to verify that the payment account is sufficient to pay for the rental and/or, in some embodiments, any damages or losses occurred to the rental item 114.

The rental processing module 208 is further configured to receive return location information 142 that includes the item location 146. In some embodiments of the invention, receipt of the item location 146 provides requisite verification that the rental item 114 has been returned to the item location 146 indicate. Based on such confirmation/verification, the rental processing module can proceed with determining rental payment amount 126 and/or processing payment for the rental amount. In addition, the return location information 142 is beneficial in providing the rental agency an exact location of the rental item for the purpose of locating the item 114 within the second designated rental area 124. As described previously the rental processing module 208 may additionally be configured to receive rental item diagnostic/status information (not shown in FIG. 3) from the application 108, which may be needed to properly determine the payment amount 154 due. Moreover, the rental processing module 208 may additionally be configured to receive comments from the renter that indicate the condition of the renter item or how the rental item performed.

Moreover, the rental processing module 208 is further configured to receive payment identifier/payment authorization 148 which may identify a payment account 154 to be used to settle the rental payment amount 154. Such communication may be received at the onset of the rental period or once the rental payment amount 126 has been determined. In addition, the rental processing module 208 is configured to, in response to processing the payment transaction for the rental, generate an communicate a payment receipt 152 to the application 108, which includes the payment amount 154 reflecting any additional charges/costs and/or discounts applied to the rental.

Referring to FIG. 4 a flow diagram is presented of a method 400 for providing automated payment amount determination for a rental period based on determining the location of a renter's mobile communication device, in accordance with embodiment of the present invention. At Event 410, rental item information is received by a wireless communication device. The rental item information includes information that identifies the item to be rented and serves to trigger/enable the self-service rental of the rental item by the renter, in possession of the wireless communication device. In alternate embodiments of the method, authentication credentials, stored on the mobile communication device, may be communicated from the device to the rental agency as a means of verifying that the mobile communication device is possessed by an individual authorized to participate in the self-service rental program or is otherwise a trusted-renter/customer authorized to participate in the self-service rental. In addition the authentication credentials may include verification of a payment account, which is to be charged upon completion of the rental. Upon verification of the authentication credentials and/or payment account, the mobile communication device may receive rental authorization which is configured to authorize the renter to rent the rental item.

At Event 420, upon receiving the rental item information and/or authenticating the renter, the mobile communication device, implementing a timing/clock mechanism and a location-determining mechanism, determines the time at which the mobile device, in possession of the renter who possess the rental item, departs a first designated geo-fenced rental area. The first time signifies the start time of the rental period.

At Event 430, the mobile communication device, implementing the timing/clock mechanism and the location-determining mechanism, determines the time at which the mobile device, in possession of the renter who possess the rental item, arrives at a second designated geo-fenced rental area. The second designated geo-fenced rental area may be the same, or similar in area encompassing, as the first designated geo-fenced rental area or, in other embodiments, the first and second designated geo-fenced area may be located at different rental agency facilities. The second time signifies the end time of the rental period.

At Event 440, based on determination of the second time and/or verification that the rental item is in a verified location within the second designated rental area, a payment amount is determined, either by the mobile communication device or another device in communication with mobile communication device. The payment amount is determined based on the first and second times, which define the rental period and a predetermined time-based rental rate.

At optional Event 450, in response to determine the payment amount or confirming the item location within the second designated rental area, a payment identifier or authorization is communicated from the mobile communication device to the rental agency. The payment identifier or authorization serves to authorize the renter's payment of the payment amount due. In response to the rental agency receiving payment for the payment amount outstanding, a payment receipt may be received, by the mobile communication device, which indicates the payment amount.

Thus, methods, systems, computer programs and the like have been disclosed that provide for self-service rental of rental items, such as vehicles, equipment and the like. The self-service aspect of the invention allows for renters to obtain the rental, leave the rental agency facility, return the rental item and pay for the rental without having to come into contact with anyone at the rental agency. As such, the present invention eliminates the need for a renter to wait in line or otherwise encounter rental agency representatives during the rental and rental return process, thereby making the rental process more efficient to the renter. Additionally, by eliminating the need for the renter to encounter rental agency representatives, the rental agency benefits by minimizing the overhead costs associated with employing rental agency representatives.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for automated determination of a rental period payment amount, the apparatus comprising:
a mobile communication device including a computing platform comprising a processor, a memory in communication with the processor and a location-determining device in communication with the processor; and
a rental application stored in the memory, executable by the processor and configured to:
receive rental item information, wherein the rental item information identifies a rental item and enables automated rental;
in response to receiving the rental item information, implement the location-determining device to determine a first time at which the mobile communication device departs a first designated rental area;
implement the location-determining device to determine a second time at which the mobile communication enters a second designated rental area; and
determine a rental period payment amount for the rental period based on the first time, the second time and a predetermined time-based payment rate.

2. The apparatus of claim 1, wherein the rental application is further configured to, in automatic response to determining the payment amount, communicate, to a rental entity providing the rental item, a payment identifier associated with a payment account, wherein the payment identifier provides for payment of the rental period payment amount.

3. The apparatus of claim 1, wherein the rental application is further configured to, in response to receiving the rental item information, communicate authentication credentials to a rental entity renting the rental item, wherein receipt of the authentication credentials by the rental entity provides for authenticating the renter.

4. The apparatus of claim 1, wherein the mobile communication device further comprises an image-capturing device and wherein the rental application is further configured to receive the rental item information by implementing the image-capturing device to capture computer-readable indicia associated with a rental item, wherein the computer-readable indicia, when read by the mobile communication device, includes the rental item information.

5. The apparatus of claim 2, wherein the rental application is further configured to, in response to communicating the payment identifier, receive a payment receipt that indicates the payment amount for renting the rental item for the payment period.

6. The apparatus of claim 1, wherein the rental application is further configured to receive return location information, wherein the return location information identifies a location within the second designated rental area where the renter has returned the rental item.

7. The apparatus of claim 6, wherein the mobile communication device further comprises an image-capturing device and wherein the rental application is further configured to receive the location identifier by implementing the image-capturing device to capture computer-readable indicia associated with the location, wherein the computer-readable indicia, when read by the mobile communication device, identifies the location.

8. A method for automated determination of a rental period payment amount, the method comprising:
receiving, by a mobile communication device, rental item information, wherein the rental item information identifies a rental item and enables rental;
in response to receiving the rental item information, determining, by location determining mechanisms within the mobile communication device, a first time at which a renter, in possession of the mobile communication device and the rental item, departs a first designated rental area;
determining, by the location determining mechanisms within the mobile communication device, a second time at which the renter, in possession of the mobile communication device and the rental item, enters a second designated rental area; and
determining, by a computing device, a payment amount for the rental period based on the first time, the second time and a predetermined time-based payment rate.

9. The method of claim 8, further comprising, in automatic response to determining the payment amount, communicating a payment identifier associated with a payment account, wherein the payment identifier provides for payment of the payment amount.

10. The method of claim 8, further comprising, in response to receiving the rental item information, communicating authentication credentials to a rental entity renting the rental item, wherein receipt of the authentication credentials by the rental entity provides for authenticating the renter.

11. The method of claim 8, wherein receiving the rental item information further comprises capturing, by an image capture device within the mobile communication device, first computer-readable indicia associated with a rental item, wherein the computer-readable indicia, when read by the mobile communication device, includes the rental item information.

12. The method of claim 9, further comprises, in response to communicating the payment identifier, receiving, by the mobile communication, a payment receipt that indicates the payment amount for renting the rental item for the payment period.

13. The method of claim 8, further comprises receiving, by the mobile communication device, return location information, wherein the return location information identifies a location within the second designated rental area where the renter has returned the rental item.

14. The method of claim 13, wherein receiving the location identifier further comprises capturing, by an image-capturing device within the mobile communication device, second computer-readable indicia associated with the location, wherein the computer-readable indicia, when read by the mobile communication device, identifies the location.

15. A computer program product, the computer program product comprising a non-transitory computer-readable medium having computer-executable instructions to cause a computer to implement the steps of:
receiving rental item information, wherein the rental item information identifies a rental item and enables automated rental
in response to receiving the rental item information, determining, by location determining mechanisms within a mobile communication device, a first time at which a renter, in possession of the mobile communication device and the rental item, departs a first designated rental area;
determining, by the location determining mechanisms within the mobile communication device, a second time at which the renter, in possession of the mobile communication device and the rental item, enters a second designated rental area; and
determining a payment amount for the rental period based on the first time, the second time and a predetermined time-based payment rate.

16. The computer program product of claim 15, wherein the steps further comprise in automatic response to determining the payment amount, communicating a payment identifier associated with a payment account, wherein the payment identifier provides for payment of the payment amount.

17. The computer program product of claim 15, wherein the steps further comprise, in response to receiving the rental item information, communicating authentication credentials to a rental entity renting the rental item, wherein receipt of the authentication credentials by the rental entity provides for authenticating the renter.

18. The computer program product of claim 15, wherein the step of receiving the rental item information further comprises capturing, by an image capture device within the mobile communication device, first computer-readable indicia associated with a rental item, wherein the computer-readable indicia, when read by the mobile communication device, includes the rental item information.

19. The computer program product of claim 16, wherein the steps further comprise, in response to communicating the payment identifier, receiving a payment receipt that indicates the payment amount for renting the rental item for the payment period.

20. The computer program product of claim 14, wherein the steps further comprise receiving return location information, wherein the return location information identifies a location within the second designated rental area where the renter has returned the rental item.

21. The computer program product of claim 20, wherein the step of receiving the return location information further comprises capturing, by an image-capturing device within the mobile communication device, second computer-readable indicia associated with the location, wherein the computer-readable indicia, when read by the mobile communication device, identifies the location.
